(19) United States
(12) Patent Application Publication
(10) Pub. No.: US 2015/0219025 A1
(43) Pub. Date: Aug. 6, 2015

(54) METHOD FOR OPERATING AN INTERNAL COMBUSTION ENGINE IN PARTICULAR A SPARK-IGNITION ENGINE, HAVING AT LEAST ONE INLET VALVE

(71) Applicant: DAIMLER AG, Stuttgart (DE)

(72) Inventor: Thomas KOCH, Pfinztal-Berghausen (DE)

(21) Appl. No.: 14/664,869

(22) Filed: Mar. 22, 2015

Related U.S. Application Data
(63) Continuation-in-part of application No. PCT/EP2013/002812, filed on Sep. 18, 2013.

(30) Foreign Application Priority Data
Sep. 21, 2012 (DE) 102012018692.4

(51) Int. Cl. F02D 41/00; F02D 13/02

(52) U.S. Cl. CPC F02D 41/0007; F02D 13/023; F02D 2041/001

(57) ABSTRACT

In a method for operating an internal combustion engine, in particular a spark-ignition engine, having inlet valves for controlling air flow to the internal combustion engine, which air flow is compressed by an exhaust gas turbocharger, wherein, during partial load operation, the inlet valves are closed at an early first point in time (t₁) or at a late second point in time (t₂), and during a transition from partial load operation to full load operation, for a predefined time, the inlet valves are closed at an early third point in time (t₃) or at a late fourth point in time (t₄) with the third point time (t₃) occurring after the first point in time (t₁) and the fourth point in time (t₄) occurring before the second point in time (t₂).

This is a Continuation-In-Part application of pending international patent application PCT/EP2013/002812 filed 2013 Sep. 18 and claiming the priority of German patent application 10 2012 018 692.4 filed 2012-09-21.

### BACKGROUND OF THE INVENTION

The present invention relates to a method for operating an internal combustion engine, in particular a spark-ignition engine, having at least one inlet valve. The invention further relates to an internal combustion engine operated in accordance with this method and a motor vehicle having an internal combustion engine.

In modern commercial vehicles, diesel engines are normally used as internal combustion engines. As a result of the design, high compression ratios, which are associated with a comparatively high thermodynamic efficiency and consequently also a high operating efficiency of a vehicle which uses such a diesel engine, are possible in such diesel engines. However both, the injection system of the diesel engine for injecting fuel into a combustion chamber of the diesel engine as well as other components of the diesel engine are relatively expensive. A further disadvantage when using a diesel engine in commercial vehicles is that the pollutant emissions generated by the diesel engine, particularly when the internal combustion engine is working at full load, are not negligible and require elaborate after-treatment of the exhaust gas. On the other hand, in spark-ignition engines which can be operated in a so-called lean mode, the exhaust gases which are produced during combustion, are almost soot-free compared in contrast to those of a diesel engine. On the other hand, the economy of spark-ignition engines is limited by a multiplicity of thermodynamic boundary conditions, In addition, with regard to the so-called knocking of fuel for spark-ignition engines, the geometric compression ratio must not exceed a predetermined limiting value which is considerably less than that of a diesel engine. Accordingly, the thermodynamic efficiency of a spark-ignition engine is less than that of a diesel engine.

In order to improve the thermodynamic efficiency of a spark-ignition engine, it can be operated in so-called Miller mode as a “Miller engine”. In such a Miller mode, a conventional spark-ignition engine is operated with an increased compression ratio compared with the normal spark-ignition engine. In order to reduce a resulting knocking of the Miller engine, the inlet valves of the cylinders of the internal combustion engine can be closed very early or very late, that is to say in particular considerably before or considerably after the crank angle of 540° associated with the bottom dead center of the piston of the internal combustion engine. This means that the intake of fresh combustion air into the combustion chamber via the inlet valve is either prematurely interrupted, or some of the air quantity which has already been drawn into the combustion chamber is forced back into the inlet tract upstream of the inlet valve. In both cases, the respective cylinder filling and the resulting compression pressure are reduced, as a result of which the undesirable occurrence of knocking in the combustion chamber can be prevented or at least reduced to a tolerable degree.

From the prior art, for example from DE 199 50 677 A1, it is known that a conventional spark-ignition engine can be operated as a Miller engine in combination with exhaust gas recirculation. Furthermore, according to this development, the internal combustion engine can be operated both in partial load operation and full load operation. In full load operation, the compression ratio can be reduced by a suitable control time setting of the inlet and exhaust valves. In addition, according to this development, supercharging by means of an exhaust gas turbocharger with a turbine arranged downstream of the internal combustion engine can also be carried out. However, a spark-ignition engine operated in this way is only suitable for full load operation to a limited extent, as the pistons of the internal combustion engine and also parts in the region of the exhaust valves which carry exhaust gas are subject to high thermal stresses, To reduce these undesirable high thermal stresses, the fuel-air mixture is normally enriched during full load operation, which, however, can lead to increased fuel consumption and also to increased pollutant emissions of the internal combustion engine.

DE 10 2006 032 719 A1 discloses a method for operating a spark-ignition engine with improved efficiency. According to this method, at least one inlet valve of the spark-ignition engine is closed very early or very late. Such a very early or very late closing of the at least one inlet valve produces a reduction in the temperature level with improved thermodynamic efficiency. The reduced filling of the cylinders due to the particular closing times of the inlet valves is at least approximately compensated for by compressing the combustion air flow by means of an exhaust gas turbocharger so that a sufficiently high power level is available. As a further measure for reducing the temperature at least at full load, a partial flow of discharged exhaust gas can be recirculated to the combustion air flow to the engine. However, a disadvantage of this method is that, in a so-called transient operation of the internal combustion engine, i.e. during a load change of the internal combustion engine from a low load to a higher load or even to full load, the efficiency of the internal combustion engine is lowered.

It is an object of the present invention to provide an improved method for operating an internal combustion engine with which the disadvantages mentioned above are eliminated or at least reduced. It is a further object of the present invention to provide a corresponding internal combustion engine for carrying out such an improved method.

### SUMMARY OF THE INVENTION

In a method for operating an internal combustion engine, in particular a spark-ignition engine, having inlet valves for controlling air flow to the internal combustion engine, which air flow is compressed by an exhaust gas turbocharger, wherein,, during partial load operation, the inlet valves are closed at an early first point in time (t₁) or at a late second point in time (t₂), and during a transition from partial load operation to full load operation, for a predefined time, the inlet valves are closed at an early third point in time (t₃) or at a late fourth point in time (t₄) with the third point time (t₃) occurring after the first point in time (t₁) and the fourth point in time (t₄) occurring before the second point in time (t₂).

The invention is based on the general idea of shifting the time of closing the inlet valve during a transition of the internal combustion engine from partial load operation to full load operation, that is to say in a so-called transient operation, for a predefined time, that is to say temporarily, in the direction toward a point in time at which the piston of the internal combustion engine is at a bottom dead center. This means that, during the transition from partial load to full load operation at the time of closing the inlet valve, the piston is closer to the bottom dead center position than during actual partial load or full load operation. In this way, an increased quantity of air is introduced into the combustion chamber for a short time during the transition from partial load to full load operation. By means of a briefly increased air mass throughput of this kind through the combustion chamber of the internal combustion engine, the turbine power of the exhaust gas turbocharger is temporarily increased, which results in a temporary increase in power output of the whole internal combustion engine. By means of the method according to the invention, the required power increase during the transition from partial load to full load operation compared with conventional methods mentioned above can be provided particularly quickly and effectively. At the same time, however, the fuel consumption of the internal combustion engine can generally be kept relatively low in transient operation as well as in partial load and full load operation.

According to the method according to the invention, in pure partial load and full load operation, the internal combustion engine is operated in a conventional Miller mode in which the inlet valve of the internal combustion engine are closed at a very early first point in time, or in a so-called Atkinson mode, in which the inlet valves of the internal combustion engine are closed at a very late second point in time. The method according to the invention is therefore based on a conventional Miller or Atkinson mode of the internal combustion engine under partial and full load respectively and on a modified method in transient operation during the transition from partial load to full load.

In a preferred embodiment, in pure full load or/and partial load operation of the internal combustion engine, the inlet valves are closed when the piston of the internal combustion engine have a relative crank angle of either substantially −70° (“Miller mode”) or substantially +70° (“Atkinson mode”) relative to a bottom dead center position of the piston of the internal combustion engine during an inlet stroke of a piston. Depending on the overall system design and with an existing but not essential variable valve train design with different and switchable cam shapes, there is a variation in crank angle of +−30° about the above stated crank angle value of 70°.

In transient operation, that is to say during the transition from partial load operation to full load operation, according to the invention, the closing time of the inlet valves of the internal combustion engine is moved for a predefined short period to, for example, a relative crank angle of substantially −67° or +67°, with respect to the bottom dead center. A particularly fast increase in power of the internal combustion engine in transient operation with, at the same time, low fuel consumption and low pollutant emissions, can be achieved in this way.

The predetermined short period is at least 0.2 ms. This ensures an adequate increase in power of the exhaust gas turbocharger by a momentarily increased exhaust gas flow to the turbine of the exhaust gas turbocharger downstream of the internal combustion engine for rapidly increasing the turbine and compressor speed during the transition to an increased or full power operation and also provides a short engine power output spike overshadowing any turbine lag.

In a further embodiment, it can be considered that the exhaust gas recirculation rate of the exhaust gas in the internal combustion engine is reduced in the predefined period. For this purpose, a low-pressure or/and high-pressure exhaust gas recirculation device of the internal combustion engine can have an appropriate adjustment valve which is partially or even fully closed in order to reduce the exhaust gas recirculation rate, so that the exhaust gas recirculation flow is temporarily reduced in transient operation compared with partial load and full load operation of the internal combustion engine.

In a particularly preferred embodiment, the opening of a wastegate device of the exhaust gas turbocharger downstream of the internal combustion engine may be closed at least for the predefined period of the transition from partial load to full load operation. By closing the wastegate opening, the turbine power of the exhaust gas turbocharger can be maximized during transient operation and therefore the increase in power required in the transient operation can be achieved quickly and effectively. Alternatively or in addition to closing the waste gate, a variable turbine geometry of the turbine of the exhaust gas turbocharger, which may be present in the exhaust gas turbocharger, can be adjusted accordingly.

To further improve the efficiency of the internal combustion engine carrying out the method according to the invention an ignition point in time of an ignition device of the internal combustion engine can be delayed, that is to say retarded, during the predefined period by a predetermined delay time or by a predetermined relative crank angle of the piston. In a particularly preferred embodiment, this predetermined relative crank angle can be substantial that is 5° to 23°, decreasing with an increasing AGR rate, relative to a top dead center of the piston of the internal combustion engine.

The invention further relates to an internal combustion engine having a supercharger which is designed for carrying out the method with one or more of the characteristics mentioned above and which has a control device which is designed in such a way that, in partial load operation, it closes at least one inlet valve of the internal combustion engine at a very early first point in time or at a very late second point in time, wherein, during a transition from partial load operation to full load operation, a so-called transient operation, for a predefined period the at least one inlet valve of the internal combustion engine closes at an early third point in time or at a late fourth point in time, and wherein the third point in time occurs after the first point in time and the fourth point in time occurs before the second point in time.

The invention also relates to a motor vehicle having an internal combustion engine according to the invention as described above and having an exhaust gas pipe in which an exhaust gas turbocharger is arranged.

Further important characteristics and advantages of the invention will become more readily apparent from the dependent claims, from the drawings and from the associated description of the figures based on the drawings.

It is understood that the characteristics stated above and still to be described below can be used not only in the specified combination in each case, but also in other combinations or in their own right without departing from the scope of the present invention.

Exemplary embodiments of the invention are shown in the drawings and are described in more detail in the following description, wherein the same references refer to the same or similar or functionally identical features.

### BRIEF DESCRIPTION OF THE DRAWINGS

FIG. 1 shows schematically an exemplary embodiment of an internal combustion engine according to the invention,

FIG. 2 shows a diagram which clarifies the relevant crank angle positions of the piston in the method according to the invention.

### DESCRIPTION OF PARTICULAR EMBODIMENT OF THE INVENTION

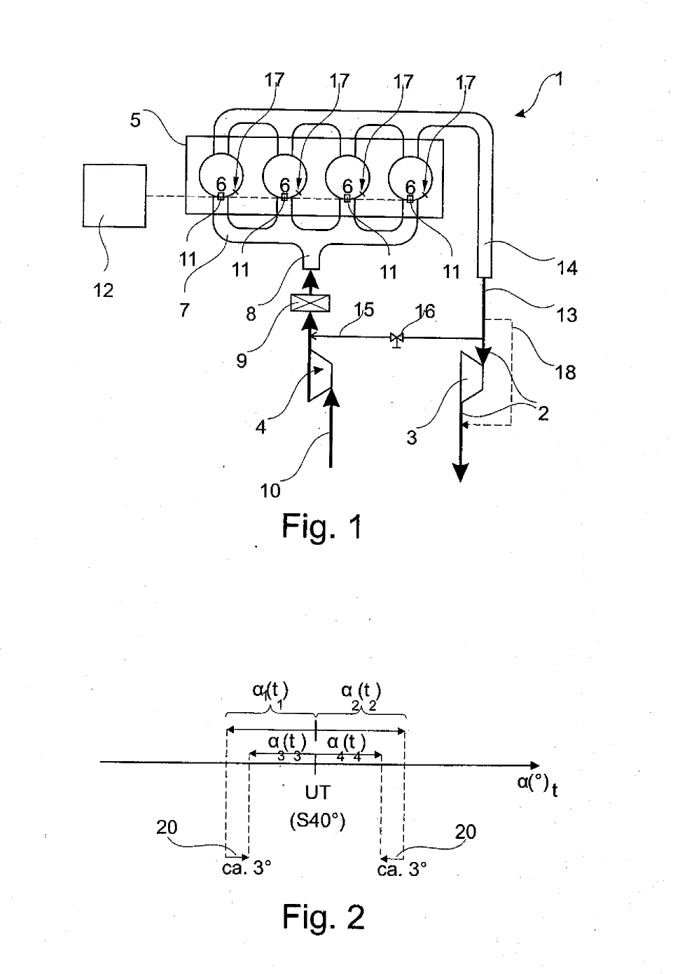

An internal combustion engine for carrying out the method according to the invention is shown schematically in FIG. 1 and designated by the numeral 1. The internal combustion engine 1 includes a supercharger 2. In the exemplary embodiment according to FIG. 1, the supercharger 2 is designed in the form of an exhaust gas turbocharger 2 with a turbine 3 and a compressor 4. A supercharger which comprises a plurality of exhaust gas turbochargers or one or more exhaust gas turbochargers and a mechanical supercharger is, of course, also conceivable. At the same time, the exhaust gas turbocharger can have a variable turbine geometry. The internal combustion engine 1 includes a cylinder block 5 in which, by way of example, four cylinders 6 are arranged. However, a different number of cylinders 6 can, of course, also be provided in variants of the exemplary embodiment. The internal combustion engine 1 is designed as a spark-ignition engine. Fresh air is fed to the cylinders 6 via an intake pipe 8 which can have an intake manifold 7. A cooler 9 can also be arranged in the intake pipe 8. The intake air to be fed to the cylinders 6 can be cooled by means of the cooler 9, thus enabling the working temperature in the cylinders 6 to be reduced in an advantageous manner. However, in a simplified variant, the cooler 9 can be omitted.

In the cylinders 6 of the internal combustion engine 1 are arranged pistons, which are movably guided up and down, which, for the sake of clarity, is not shown in FIG. 1 In the method according to the invention, the air mass flow fed to the internal combustion engine 1 is compressed with the help of the exhaust gas turbocharger 2. In order to form a fuel-air mixture to be burnt in the cylinders 6, fuel is injected either into the intake pipe 8 (intake-manifold fuel injection) or directly into the cylinders 6 (direct injection).

The air mass flow (cf. arrow 10) into the cylinders 6 is controlled by inlet valves 11 which are shown only highly schematically. Each cylinder 6 has at least one inlet valve 11. The inlet valves 11 can be adjusted between an open and a closed state, wherein a degree of opening of the inlet valves 11 can be adjusted by means of a control device 12.

The exhaust gases which are produced during the combustion of the fuel-air mixture in the cylinders 6 are conducted out of the cylinders 6 via an exhaust gas pipe 14 as an exhaust gas flow (cf. arrow 13). The discharge of the exhaust gas flow 13 is controlled by means of discharge valves which are not shown in FIG. 1 and which, like the inlet valves 11, are associated with the individual cylinders 6.

The exhaust gas pipe 14 is connected to the intake pipe 8 by means of a high-pressure exhaust gas recirculation pipe 15. Alternatively or in addition to the high-pressure exhaust gas recirculation pipe 15, low-pressure exhaust gas recirculation, which is not shown in FIG. 1, can also be provided. The high-pressure exhaust gas recirculation pipe 15 can have an actuator 16 in the form of a high-pressure valve, by means of which the exhaust gas mass flow to be recirculated can be adjusted. This applies in a similar manner to the low-pressure exhaust gas recirculation if provided.

The portion of the exhaust gas flow which is not recirculated is fed through the turbine 3 of the exhaust gas turbocharger 2, the compressor 4 of the exhaust gas turbocharger 2 being driven by the turbine 3. The compressor 4 compresses the combustion air flow before it is introduced into the cylinders 6. The exhaust gas recirculation pipe 15 branches off the exhaust gas pipe 14 upstream of the turbine 3 as so-called high-pressure exhaust gas recirculation pipe, and also, alternatively or in addition, as already explained, an exhaust gas recirculation pipe may branch off the exhaust gas pipe 14 downstream of the turbine 3 for so-called low-pressure exhaust gas recirculation (not shown).

During partial load operation, the respective inlet valves 11 of the cylinders 6 of the internal combustion engine 1 are in each case closed either at an early first point in time t₁ (Miller mode) or at a late second point in time t₂ (Atkinson mode). In doing so, in partial load operation, the inlet valves 11 close exactly when the pistons of the cylinders 6 of the internal combustion engine 1 have a relative crank angle of either substantially −70° (Miller mode) or substantially +70° (Atkinson mode) relative to a bottom dead center position of the respective piston associated with an inlet stroke of the internal combustion engine 1. This is shown in more detail in the representation of FIG. 2, which shows the crank angle a of the piston of a particular cylinder 6 in a simplified diagram. Here, the bottom dead center of the piston is designated by “UT”. The bottom dead center UT corresponds to an absolute piston angle of 540° with the a power stroke being the first stroke.

Even in steady-state full load operation, the engine must also operate with early or late closing of the inlet valves 11 for efficiency reasons.

According to the invention, in partial load operation, the at least one inlet valve 11 of the internal combustion engine 1 is now closed at a very early first point in time t₁ (Miller mode) or at a very late second point in time t₂ (Atkinson mode). Here, the first point in time t₁ corresponds to a relative crank angle α₁ (relative to the bottom dead center UT) or a relative crank angle α₂ likewise relative to the bottom dead center UT, wherein the relative crank angle α₁ associated with the very early first point in time t₁ is substantially −40° to −100° and the relative crank angle β₂ associated with the very late second point in time t₂ is substantially +40° to +100°. Preferably the crank angle α₁ is substantially −70° and the crank angle α₂ substantially +70°.

According to the invention, in transient operation of the internal combustion engine 1, that is to say during the transition from partial load operation to full load operation, the respective relative crank angle α₁or α₂ is now reduced towards the bottom dead center UT, namely for a predefined time which is preferably at least 2 ms. Preferably, the relative shift of the relative crank angle α towards the bottom dead center can be at least 3°, which means that the very early first point in time t₁ associated with the first relative crank angle α₁ shifts towards an early third point in time t₃, wherein the early third point in time t₃ occurs after the first point in time t₁. Correspondingly, the very late second point t₂ in time shifts towards a late fourth point in time t₄ which occurs before the very late second point in time t₂. Transcribed to the crank angle α, this means that the relative crank angle in each case shifts by at least 3° towards the bottom dead center UT, which is intended to be expressed in FIG. 2 by the arrows with the designation 20. Consequently, in transient operation, the inlet valves 11 close at a relative crank angle α of substantially −67° (Miller) or +67° (Atkinson). Here, the corresponding relative crank angles are designated in FIG. 2 by α₃ (Miller mode) and α₄ (Atkinson mode) respectively.

In the predefined time, which is preferably at least 0.2 ms, an exhaust gas recirculation rate of exhaust gas which is recirculated by means of the high-pressure exhaust gas recirculation pipe 15 can be reduced by appropriate adjustment of the actuator 16, at least for the predefined time, to a predetermined relative value, for example 80% of a normal recirculation rate, in partial and full load operation of the internal combustion engine 1. In this way, the turbine power of the turbine 3 of the exhaust gas turbocharger 2 can be temporarily increased, which also leads to an increased compressor power of the compressor 4 of the exhaust gas turbocharger 2 and therefore to an increase in power of the whole internal combustion engine 1.

During the predefined time, an ignition point of an ignition device 17, which in each case is arranged in each of the cylinders 6 and is shown only highly schematically in FIG. 1, can be delayed by a predetermined delay time or by a predetermined relative crank angle α_{Z} of the appropriate piston of the cylinders 6. The ignition point is adjusted in the late adjustment direction. Here, the predetermined relative crank angle α_{Z} is preferably substantially +5° to +23° relative to a top dead center (“OT”) of the respective piston of the cylinders 6 of the internal combustion engine 1 associated with an ignition stroke of the internal combustion engine 1.

Alternatively or in addition, at least for the predefined time, a wastegate opening of a wastegate device 18 of the exhaust gas turbocharger 2 downstream of the internal combustion engine 1, which is only indicated highly schematically in FIG. 1, can be closed at least for the predefined time of the transition from partial load to full load operation in order to thereby increase the turbine power of the turbine 3 and therefore also the compressor power of the compressor 4 of the exhaust gas turbocharger 2.

What claimed is:

1. A method for operating an internal combustion engine (1), in particular a spark ignition engine, having for each cylinder at least one inlet valve (11), the method comprising the steps of:
compressing a charge air supplied to the internal combustion engine (1) by means of an exhaust gas turbocharger (2),
in partial load operation of the internal combustion engine (1), closing the at least one inlet valve (11) at an early first point in time (t₁) or at a late second point in time (t₂), and
during a transition from partial load operation to full load operation, closing for a predefined period the at least one inlet valve (11) at an early third point in time (t₃) or at a late fourth point in time (t₄), wherein the third point in time (t₃) is later than the first point in time (t₁) and the fourth point in time (t₄) is earlier than the second point in time (t₂).

2. The method as claimed in claim 1, wherein in partial load operation of the internal combustion engine (1), each inlet valve (11) is closed when an associated piston of the internal combustion engine (1) has a relative crank angle (α₁ or α₂) of either substantially −40° to −100° or substantially +40° to 100° relative to a bottom dead center (UT) of the piston associated with an inlet stroke of the internal combustion engine (1).

3. The method as claimed in claim 1, wherein in partial load operation of the internal combustion engine (1), each inlet valve (11) is closed when an associated piston of the internal combustion engine (1) has a relative crank angle (α₁ or α₂) of either substantially −70° or substantially +70° relative to a bottom dead center (UT) of the piston associated with an inlet stroke of the internal combustion engine (1), and during the transition of the internal combustion engine (1) from partial load operation to full load operation, the at least one inlet valve (11) is closed for the predefined period at a relative crank angle (α₃ or α₄) of substantially −67° or +67°.

4. The method as claimed in claim 1, wherein the predefined time is at least 0.2 ms.

5. The method as claimed in claim 1, wherein the exhaust gas recirculation rate is reduced in the predefined period.

6. The method as claimed in claim 1, wherein a waste gate device (18) of the exhaust gas turbocharger (2) arranged downstream of the internal combustion engine (1) is closed at least for the predefined period of the transition.

7. The method as claimed in claim 1, wherein an ignition point of an ignition device (17) of the internal combustion engine (1) is delayed during the predefined period by a predetermined delay time or by a predetermined relative crank angle of the piston.

8. The method as claimed in claim 7, wherein the predetermined relative crank angle is substantially +5° to +23° relative to a top dead center (OT) of the piston associated with an ignition stroke of the internal combustion engine (1).

9. An internal combustion engine (1) having a supercharger (2) which is designed for carrying out the method as claimed in claim 1, the internal combustion engine having a control device (12) which is designed in such a way that
in partial load operation, the inlet valves (11) of the internal combustion engine (1) close at an early first point in time (t₁) or at a late second point in time (t₂), and
during a transition from partial load operation to full load operation, for a predefined period the inlet valves (11) of the internal combustion engine (1) are closed at an early third point in time (t₃) or at a late fourth point in time (t₄), wherein the third point in time (t₃) occurs after the first point in time (t₁) and the fourth point in time (t₄) occurs before the second point in time (t₂).

10. An internal combustion engine (1) as claimed in claim 9 including an exhaust gas pipe (14) in which an exhaust gas turbocharger (2) is arranged.

11. A motor vehicle having an internal combustion engine as claimed in claim 9.
